(19) United States
(12) Patent Application Publication
(10) Pub. No.: US 2026/0274214 A1
(43) Pub. Date: Sep. 17, 2026

(54) UNCOUPLING A TRAILER FROM A TRACTOR

(71) Applicant: ZF CV SYSTEMS GLOBAL GMBH, Bern (CH)

(72) Inventors: Rüdiger MEYER, Hannover (DE); Timo Isermann, Wedemark (DE)

(21) Appl. No.: 19/472,714

(22) PCT Filed: Apr. 2, 2024
(86) PCT No.: PCT/EP2024/058865

§ 371 Date: Oct. 6, 2025

(30) Foreign Application Priority Data
Apr. 6, 2023 (DE) 10 2023 108 941.2

(51) Int. Cl. B60S 9/02; B60D 1/36

(52) U.S. Cl. CPC B60S 9/02; B60D 1/36

(57) ABSTRACT

A method for assisting a decoupling operation of a tractor from a semitrailer is provided. The semitrailer includes a left support leg and a right support leg, which can be extended independently of each other. A first and a second load of the semitrailer, which acts on the left support leg and the right support leg respectively, is determined. A support leg of the left support leg and the right support leg is individually extended, a load of which lies below an associated predetermined threshold value. An opening of a coupling of the tractor to the semitrailer is released based on determining that a load of the semitrailer, which acts on the tractor, is less than a predetermined further threshold value.

### CROSS REFERENCE TO RELATED APPLICATIONS

This application is a U.S. National Phase application under 35 U.S.C. § 371 of International Application No. PCT/EP 2024/058865, filed on Apr. 2, 2024, and claims benefit to German Patent Application No. DE 10 2023 108 941.2, filed on Apr. 6, 2023. The International Application was published in German on Oct. 10, 2024 as WO 2024/208795 A1 under PCT Article 21(2).

### FIELD

The present disclosure relates to a commercial vehicle comprising a tractor with a semitrailer. In particular, the present disclosure relates to the decoupling of the semitrailer from the tractor.

### BACKGROUND

A commercial road trailer having at least one axle with wheels at a rear end is designed at its front end to rest on and to be towed by a tractor. Such a trailer is also known as a semitrailer-trailer or a semitrailer. The tractor may also be called a semitrailer tractor. In order to disconnect the semitrailer from the tractor, support legs can be extended downward in the front region of the semitrailer to take over the weight load thereof. A tractive connection to the tractor can then be disconnected and the tractor moved away.

For improved utilization of the tractor, automating a decoupling operation between the tractor and the semitrailer is desirable. It may be problematic if the surface is uneven such that the tractor and/or the semitrailer stand with a lateral inclination on the surface. Disconnecting a connection between the tractor and the semitrailer may be hampered as a result.

WO 2022/077063 A1 relates to a technique for loading or unloading a vehicle trailer with loading ramps attached to the rear of the vehicle. In order to be able to drive another vehicle safely over the loading ramps, even on a steep surface, it is proposed to design the lengths of the loading ramps and a pitch angle and a rolling angle of the vehicle trailer to be controllable.

### SUMMARY

In an embodiment, the present disclosure provides a method for assisting a decoupling operation of a tractor from a semitrailer. The semitrailer includes a left support leg and a right support leg, which can be extended independently of each other. A first and a second load of the semitrailer, which acts on the left support leg and the right support leg respectively, is determined. A support leg of the left support leg and the right support leg is individually extended, a load of which lies below an associated predetermined threshold value. An opening of a coupling of the tractor to the semitrailer is released based on determining that a load of the semitrailer, which acts on the tractor, is less than a predetermined further threshold value.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a vehicle system comprising a tractor and a semitrailer, according to an embodiment of the present disclosure;

FIG. 2 shows an exemplary relative position of a tractor relative to a semitrailer, according to an embodiment of the present disclosure;

FIG. 3 shows a control system, according to an embodiment of the present disclosure; and

FIG. 4 shows a flow diagram of a method, according to an embodiment of the present disclosure.

### DETAILED DESCRIPTION

In accordance with an embodiment, the present disclosure provides an improved technique for decoupling a semitrailer from a tractor.

According to a first aspect of the present disclosure, a method for assisting a decoupling operation of a tractor from a semitrailer, wherein the semitrailer comprises a left and a right support leg, which can be extended independently of each other, comprises the steps of determining a first load of the semitrailer, which acts on the left support leg; of determining a second load of the semitrailer, which acts on the right support leg; of individually extending a support leg, the specific load of which lies below an associated predetermined threshold value; and of releasing the opening of a coupling of the tractor to the semitrailer if a load of the semitrailer, which acts on the tractor, is less than a predetermined further threshold value.

A decoupling operation may comprise decoupling the tractor from the semitrailer, i.e., disconnecting a tractive connection between the tractor and the semitrailer. A fifth-wheel coupling can be attached to the tractor and a king pin to the semitrailer, and the decoupling can comprise an opening fifth-wheel coupling so that the king pin can be removed from the fifth-wheel coupling. The tractor can then move away from the semitrailer.

It can be determined which of the support legs supports the smaller load, with it being possible only for this support leg to be extended, while the other support leg is halted. An energy source for extending the support legs can thereby be subjected to less severe loading. During the determination of the loads, a predetermined hysteresis, i.e., a tolerable deviation between the loads, can be taken into account in order to avoid too frequent switching between an actuation of the right and the left support leg. The support legs can be extended step by step, and therefore a correct position of the semitrailer can be better controlled.

The decoupling of the tractor can be released only if an amount of a deviation between loads acting on the support legs falls short of a predetermined threshold value. In particular, it can thereby be ensured that the semitrailer is not excessively laterally inclined about its longitudinal axis during the decoupling. The semitrailer can also be safely parked even if a surface is uneven and lengths which the support legs each have to overcome are unequal.

The support legs can be extended in such a way that the decoupling of the tractor is released only if an amount of a deviation between effective lengths of the support legs lies below a predetermined threshold value. Should the deviation exceed the threshold value, the semitrailer is too oblique in relation to gravity. If the supports have to be extended to very different degrees to receive identical loads, this is an indication that the tractor is sloping. It is therefore useful to check the difference in the support stroke and, in the event of a high value, to prevent the decoupling.

The support legs can be extended in such a way that a deviation of an absolute rolling angle of the semitrailer from the vertical falls short of a predetermined threshold value.

An absolute rolling angle of a vehicle is usually defined as the orientation of the vehicle about its longitudinal axis. A vertical that corresponds to the direction of gravity is conventionally used as reference. If the vehicle is standing upright, its absolute rolling angle is 0°. By monitoring the absolute rolling angle, it is possible to prevent the semitrailer from being disconnected from the tractor in an excessively inclined position.

If, for example, the semitrailer is unevenly loaded with respect to its longitudinal axis, an absolute rolling angle of 0° cannot be achieved, while at the same time loads on the support legs are identical in size. Therefore, a predetermined deviation of the support loads from each other can be tolerated in order to keep the absolute rolling angle small enough.

The support legs can be extended in such a way that an amount of a relative rolling angle between the semitrailer and the tractor falls short of a predetermined threshold value. A deviation in the rolling angles of the vehicles may occur if the design of the fifth-wheel coupling allows a deviation in the coupled state.

A relative rolling angle between the tractor and the semitrailer relates to a deviation in orientations of the two vehicles about their rolling axes. In other words, the relative rolling angle can indicate how strongly one of the vehicles is twisted relative to the other. The relative rolling angle can also be determined if the longitudinal axes of the vehicles do not intersect at a point or are offset from each other. The relative rolling angle can be measured directly between the vehicles or absolute rolling angles of the two vehicles can be determined and subtracted from each other. For example, if the tractor is inclined by +5° and the semitrailer by −5° relative to the vertical, the relative rolling angle between the vehicles can be +5°−(−5°)=10°.

A load acting on a support leg can be determined on the basis of a load acting on a wheel which is mounted on the same side as the support leg. In different embodiments, the wheel may be encompassed either by the tractor or by the semitrailer. A load acting on a left support leg may be dependent on a load acting on a left wheel of the semitrailer or on a left wheel of the tractor. Accordingly, a load acting on a right support leg of the semitrailer may be a load acting on a right wheel of the semitrailer or on a right wheel of the tractor. These relationships can each be linear. A load acting on a wheel can be determined, for example, by means of a dedicated sensor or on the basis of a pressure on the wheel in a pneumatic chassis. A load acting on a support leg can be determined by taking into account lever ratios existing between a wheel of the tractor and the support leg or between the support leg and a wheel of the semitrailer.

According to a further aspect of the present disclosure, a control system for assisting a decoupling operation of a semitrailer having a left and a right support leg from a tractor comprises: a first scanning device for determining loads of the semitrailer, which in each case act on the support legs; a left actuator for extending the left support leg; a right actuator for extending the right support leg; a control apparatus for individually controlling the extension of a support leg, the associated load of which lies below a predetermined threshold value; and a second scanning device for determining a load of the semitrailer, which acts on the tractor. In this case, the control apparatus is designed to release opening of a coupling of the tractor to the semitrailer, if the load of the semitrailer, which acts on the tractor, is less than a predetermined further threshold value.

The control apparatus may be designed to carry out a method described herein in whole or in part. For this purpose, the processing device may be electronic and comprise a programmable microcomputer or microcontroller, and the method may be in the form of a computer program product with program code means. The computer program product may also be stored on a computer-readable data carrier. Features or advantages of the method can be transferred to the apparatus or vice versa.

According to yet another aspect of the present disclosure, a vehicle comprises a control system described herein. In particular, the vehicle may comprise a tractor or a semitrailer.

Yet another aspect of the present disclosure relates to a vehicle system having a tractor and a semitrailer. The vehicle system, which may also be called a semi-truck, comprises a control system described herein. The control system can be designed to assist an automatic decoupling operation of the semitrailer from the tractor. Components included in the control system can each alternatively be provided by the tractor and/or by the semitrailer.

A load acting on a support leg can be determined on the basis of a load acting on a wheel of the semitrailer. In particular, a load acting on a wheel mounted on the same side as the support leg can be determined. In a corresponding manner, a load interacting with both support legs can be determined on the basis of an overall load, minus a load acting on the wheels of the semitrailer.

The disclosure will now be described in more detail with reference to the accompanying figures.

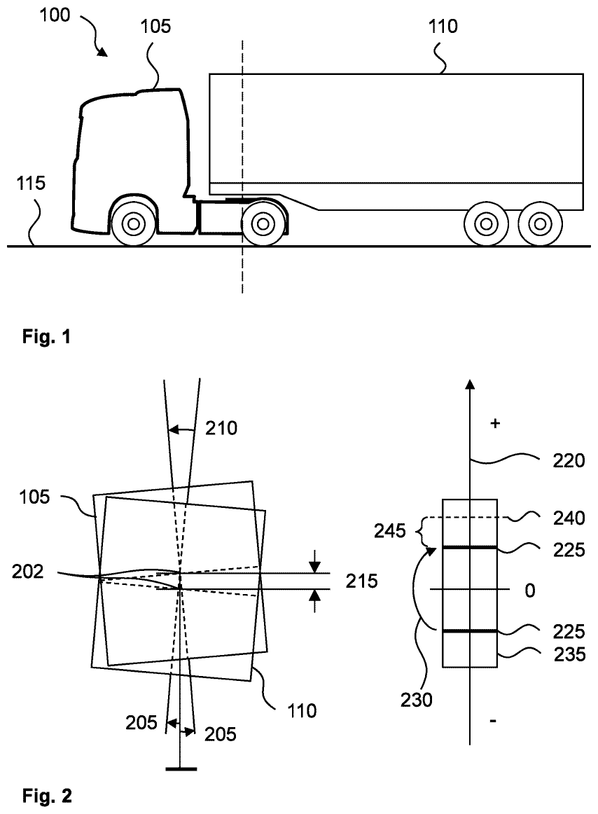

FIG. 1 shows a vehicle system 100 which comprises a tractor 105 and a semitrailer 110. The tractor 105 can be disconnected from the semitrailer 110, in order, for example, to be connected to another semitrailer 110. A vertical interrupted line indicates the location at which the vehicles 105, 110 can be disconnected from each other. Connecting the vehicles 105, 110 is referred to as coupling up or coupling, and disconnecting as decoupling.

During the decoupling, the vehicles 105, 110 stand on a surface 115 which is ideally flat and horizontal, but in practice is inclined, uneven or has a differing degree of load-bearing capacity. A technique described herein relates to a decoupling operation between the vehicles 105, 110 even under such difficult conditions. For this purpose, the semitrailer 110 is supported in such a way that the tractor 105 can be decoupled and moved away from the semitrailer 110.

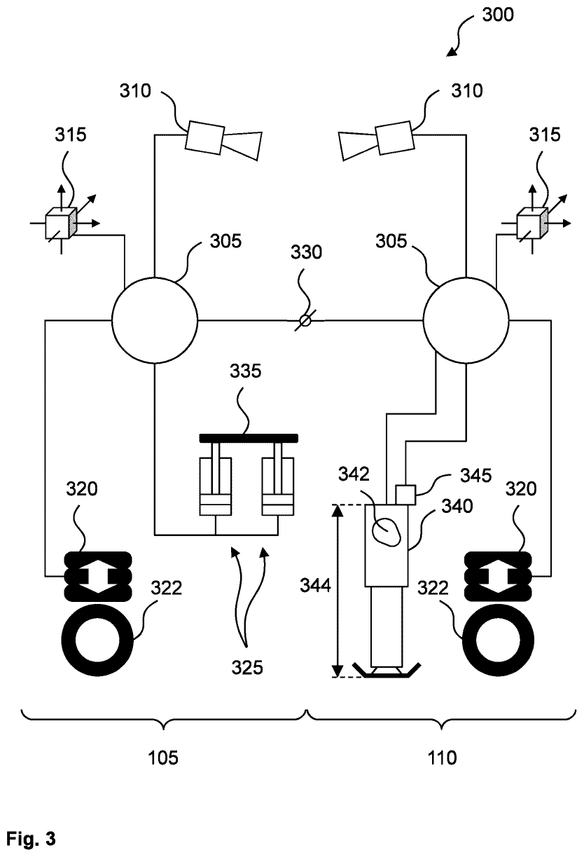

FIG. 2 shows an exemplary relative position of a tractor 105 relative to a semitrailer 110. The view shown corresponds to a longitudinal section through the vehicle system 100 from FIG. 1 along a plane containing the interrupted line. The vehicles 105, 110 are each symbolized here as squares. Each square is halved both longitudinally and transversely by means of an interrupted line, with a longitudinal axis 202 of the associated vehicle 105, 110 running through an intersection of the interrupted lines.

It can be seen that the squares representing the vehicles 105, 110 are each twisted by an absolute rolling angle 205 relative to a vertical. As a result, the vehicles 105, 110 are twisted in relation to each other about a relative rolling angle 210. The absolute rolling angles 205 are opposed to each other, with it being possible for the relative rolling angle 210 to be determined as a deviation of the absolute rolling angles 205. If the relative twisting is of sufficient strength so that an amount of the relative rolling angle 210 exceeds a predetermined threshold value, large forces which may put the stability of the vehicles 105, 110 at risk may occur during the decoupling of the tractor 105 at the semitrailer 110.

Also shown in FIG. 2 is a relative height 215 between the tractor 105 and the semitrailer 110. The relative height 215 is shown here as the vertical distance of the longitudinal axes 202 of the vehicles 105 and 110. If the tractor 105 carries the load of the semitrailer 110, the relative height 215 is zero. For the decoupling, the tractor 105 can be lowered while the semitrailer 110 is supported on support legs. The relative height 215 assumes a value which lies below a predetermined maximum value. After the fifth-wheel coupling has been disconnected, the tractor 105 can be moved away from the semitrailer 110.

It should be noted that in practice the longitudinal axes of the vehicles 105, 110 are rarely exactly aligned with each other, but often enclose an angle with each other or are offset horizontally by a certain degree in relation to each other. The determination of the relative rolling angle 210 or of the relative height 215 in the region of a coupling apparatus between the tractor 105 and the semitrailer 110 can nevertheless be carried out in a manner described herein. Smaller disturbance variables or inconsistencies in the determination of the relative rolling angle or of the relative height may be ignored.

With regard to values and the comparison thereof, an illustration is given in the right-hand region of FIG. 2. A value 225 is determined on a predetermined scale 220. A value 225 lying above the line denoted by zero is positive, and a value 225 lying below it is negative. An amount 230 of a positive value 225 corresponds to the unchanged value 225; that of a negative value 225 corresponds to its value 225 multiplied by (−1).

A value 225 can be compared with a range 235. In this case, the value 225 may relate in particular to a load. During the comparison, it can be determined whether the value 225 lies within or outside the range 235. Limits of the range 235 can be included in or excluded from the range 235. A value 225 can also be compared with a threshold value 240. It is possible to determine whether the value 225 lies below, on or above the threshold value 240. A deviation 245 between a value 225 and another value, for example a threshold value 240, can be determined as the numerical difference of corresponding numerical values of the values 225. In various embodiments, the deviation 245 can be determined absolutely or as an amount 230.

FIG. 3 shows a control system 300 for assisting an automatic decoupling operation of a tractor 105 from a semitrailer 110. The control system 300 is designed by way of example substantially symmetrically by some components being provided both on the tractor 105 and on the semitrailer 110. It may be sufficient to provide such a component in each case only on one side, i.e., only on the tractor 105 or on the semitrailer 110. It should also be noted that some components on the tractor 105 and the semitrailer 110 that act similarly with respect to the present disclosure may be realized differently, as is described in more detail below.

In the embodiment shown, the control system 300 on the tractor 105 comprises a control apparatus 305, a first sensor 310, a second sensor 315, and a first actuator 320 and a second actuator 325. In some embodiments, only one sensor 310, 315 or only one actuator 320, 325 is provided. In some embodiments, an interface 330 is provided for communication with a component on the semitrailer 110. The interface 330 can be wired or wireless.

The control apparatus 305 may comprise a conventional control unit with a processing device. The control apparatus 305 is optionally designed to carry out tasks other than those described herein. In some embodiments, the control apparatus 305 may be connected to another component on board the tractor 105, in particular to allow interaction with the other component or a person. In some additional embodiments, the control apparatus 305 may be designed to output a warning signal. In one embodiment, the warning signal can be output via an interface to a control unit or control system. In another embodiment, the warning signal can be output to a person in the region of the vehicle system 100, in particular to a driver of the tractor 105.

The first sensor 310 may be fixedly attached to the tractor 105 and designed to scan the semitrailer 110. The scanning may also take place contactlessly, for example by means of an ultrasonic sensor, a radar sensor or a LiDAR sensor. Optionally, a signal transmitter, a marking or a reflex element is attached to the semitrailer 110 in order to facilitate scanning by the first sensor 310. For example, a marking may consist of a retroreflective material. The first sensor 310 can determine a relative alignment of the semitrailer 110 with respect to the tractor 105. In some embodiments, the first sensor 310 may be provided in the region of a coupling apparatus between the tractor 105 and the semitrailer 110.

The second sensor 315 may comprise an acceleration sensor, an inertial platform or a similar sensor, which is designed to determine an absolute rolling angle of the tractor 105 with respect to a field of gravity of the Earth. The second sensor 315 can optionally be sensitive about a plurality of axes and thus can also determine a pitch angle or a yaw angle of the tractor 105.

The first actuator 320 is designed to control a height of a rear end of the tractor 105. In some embodiments, two first actuators 320 are provided, which can be actuated independently of each other to raise or lower the rear end of the tractor 105 either only on the left or only on the right. Purely by way of example, the first actuator 320 is shown as bellows of a pneumatic chassis. The bellows 320 elastically support a wheel 322 of the tractor 105 and can control a height of the tractor 105 above a surface on which the wheel 322 is standing. Other realizations are also possible.

The second actuator 325 is designed to influence a height and/or a rolling angle of a coupling element for the semitrailer 110 on the tractor 105. The coupling element comprises, by way of example, a fifth-wheel plate 335, may be designed as a fifth-wheel coupling plate. The second actuator 325 comprises, by way of example, two pneumatic or hydraulic actuators, one of which is provided on the left and one on the right side of the tractor 105. Other embodiments are also possible here.

In the embodiment shown, a control apparatus 305, a first sensor 310, a second sensor 315, and a first actuator 320 are provided on the semitrailer 110 in a manner corresponding to the tractor 105. Functions of these components are described with reference to the components on the tractor 105 and can be applied accordingly on the semitrailer 110.

Two support legs 340 can be provided on the semitrailer 110, one of which is mounted at the front left in the direction of travel and the other at the front right in the direction of travel. The support legs 340 are designed to support a load in a front region of the semitrailer 110 relative to the surface 115 when the semitrailer 110 is not resting at the front on the fifth-wheel plate 335 of the tractor 105. A support leg 340 comprises an actuator 342 in order to retract or extend it, for example pneumatically, hydraulically or electromotively. An effective length 344 of the support leg 340 in the vertical direction can be changed. If the support leg 340 stands on a surface, then, in some embodiments, a distance between a chassis of the semitrailer 110 and the surface can be controlled by actuation of the actuator 342. In some embodiments, the left support leg 340 and the right support leg 340 may each be able to be retracted and extended independently of each other. In some additional embodiments, an associated load sensor 345 is provided on each of the support legs 340, said load sensor being designed to determine a load of the semitrailer 110, which acts on the support leg 340.

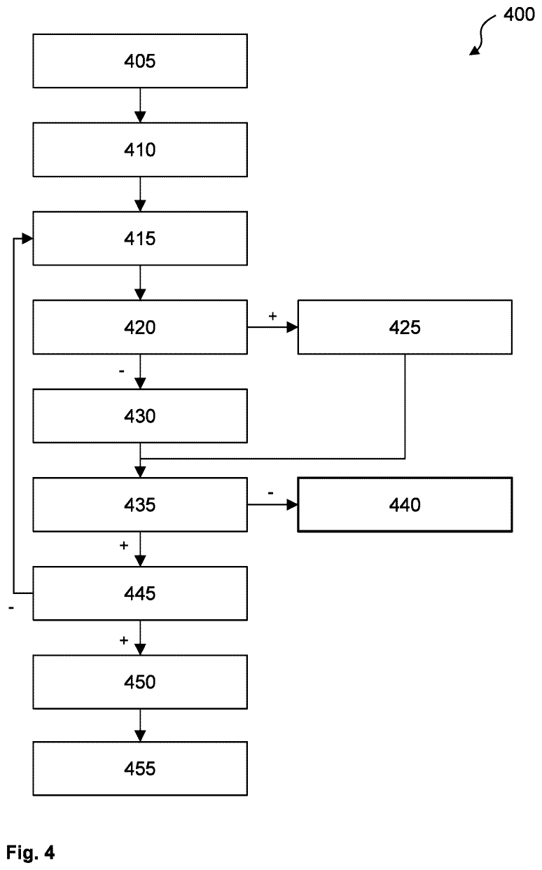

FIG. 4 shows a flow diagram of a method 400. The method 400 can be carried out by means of one or more interconnected control devices 405 of a vehicle system 100 and is designed to assist a decoupling operation of a tractor 110 from a semitrailer 115.

In a step 405, a request for automatic decoupling of a tractor 105 from a semitrailer 110 may be determined. The request may, for example, be provided by a person or a control system on board one of the vehicles 105, 110. At this time, the tractor 105 and the semitrailer 110 may be tractively connected to each other, and a front end of the semitrailer 110 rests on a coupling apparatus, in particular a fifth-wheel plate 335, on a rear end of the tractor 105. The vehicles 105, 110 are stationary on the surface 115. Alternatively, a decoupling operation which is carried out manually can be determined or started in this step.

In a step 410, support legs 340 of the semitrailer 110 can be extended. The aim of the extension is to support a load of the semitrailer 110 at its front end in relation to the surface 115 so that the tractor 105 can be relieved of load. The extension takes place by actuators 342 of the support legs 340 being correspondingly activated.

In a step 415, effective loads of the semitrailer 110 on a right side and a left side can be determined. A first specific load acts on the left support leg 340, a second load on the right support leg 340. The first and the second load can each be determined by means of an associated load sensor 345 on the relevant support leg 340. Alternatively, the first or second load can be determined on the basis of an overall load of the semitrailer 110 minus loads acting on wheels of the semitrailer 110. This determination can be carried out summarily for both sides or for the right and left sides separately. Loads acting on the wheels can be determined, for example, via pneumatic pressures of an air suspension system with which a chassis of the semitrailer 110 is supported in relation to the wheels.

In one embodiment, the support legs 340 are initially extended simultaneously to such an extent that they each come into contact with the surface 115. It can be determined that a support leg 340 has reached the surface 115 when a load acting on the support leg 340 exceeds an associated first threshold value 240. Conventionally, the same first threshold values 240 are associated with both support legs 340. If the surface 115 is uneven, the support legs 340 may have to bridge vertical heights of differing size before the respectively transmitted load reaches the first threshold value 240. Accordingly, the extension of the left support leg 340 and the extension of the right support leg 340 may last unequal lengths of time.

The support legs 340 can then be extended further to relieve the load on the tractor 105. For this purpose, it can be determined, in a step 420, whether the load acting on the left support leg 340 is greater than the load acting on the right support leg 340. In this case, in a step 425, the right support leg 340 can be extended further while the left support leg 340 is halted.

Otherwise, in a step 430, the left support leg 340 can be extended while the right support leg 340 is halted. In other words, the support leg 340 which currently carries the smaller load can be extended further.

If the semitrailer 110 is uniformly loaded in the transverse direction and identical loads act on the left and the right support leg 340, the absolute rolling angle 210 of the semitrailer 110 with respect to gravity should be substantially zero. However, the absolute rolling angle 210 may deviate from zero, for example, if one of the support legs 340 cannot be extended further before the support legs 340 have taken over a sufficient load.

Therefore, during the extension of the support legs 340, the absolute rolling angle 210 of the semitrailer 110 can be determined by means of one or more of the sensors 310, 315. If an amount of the absolute rolling angle 210 exceeds an associated threshold value 240 with respect to the vertical or gravity, a warning signal can be output. In this case, the method 400 may also be broken off in a step 450, as described more precisely below. Alternatively, an attempt can be made to minimize the absolute rolling angle 210 by the support legs 340 being suitably actuated. A predetermined imbalance between loads acting on the support legs 340 may be accepted here. If the imbalance between the support loads or the deviation of the rolling angle of the semitrailer 110 from the vertical is excessive, the method 400 can be broken off in step 450.

If the tractor 105 and the semitrailer 110 stand parallel to a slope, the semitrailer 110 can be substantially vertical if support loads on the support legs 340 are identical. However, the tractor 105 may be aligned in relation to the surface 115 such that a relative rolling angle 210 between the tractor 105 and the semitrailer 110 can be set.

During the extension of the support legs 340, the relative rolling angle 210 between the tractor 105 and the semitrailer 110 can therefore be monitored. If an amount of the relative rolling angle 210 exceeds an associated, predetermined threshold value 240, a warning signal can be output. If an actuator 325 is available on the tractor 105, said actuator can be activated in order to laterally pivot the tractor and to minimize the relative rolling angle 210. The tractor 105 can also be lifted laterally on the left or right to reduce the relative rolling angle 210. The support legs 340 can also be actuated to reduce the relative rolling angle 210. In one of the compensation measures, a predetermined imbalance between loads acting on the support legs 340 may be accepted. If the relative rolling angle 210 or the imbalance is excessive, the method 400 can be broken off in step 450.

In one embodiment, the extension of the support legs 340 can be ended when loads which are supported by the support legs 340 in each case exceed associated second threshold values 240. The second threshold values 240 may be identical. In this embodiment, the support legs 340 can also be extended simultaneously, while their respective loads lie between the associated first and the associated second threshold value 240. The extension of a support leg 340 can be ended if its supported load exceeds the associated second threshold value 240.

In another embodiment, the extension of the support legs 340 can be ended in a step 435 depending on a load acting on the tractor 105. To determine the load, a corresponding sensor can be used on the fifth-wheel plate 435 of the tractor. Alternatively, the load acting on the tractor 105 can be determined on the basis of a pneumatic pressure in an air suspension system of wheels, in particular rear wheels, of the tractor 105. A load of the tractor 105 can be subtracted from a load determined in this way to determine the load of the semitrailer. Optionally, lever ratios between rear wheels of the tractor 105, support legs 340 and rear wheels of the semitrailer 110 can be taken into account in order to determine the load of the semitrailer 110, which acts on the support legs 340, on the basis of a wheel load or axle load.

If the load of the semitrailer 110, which acts on the tractor 105, falls short of an associated third threshold value 240, the support legs 340 can be halted in a step 440. A lock between the tractor 105 and the semitrailer 110 can be released so that the tractor can be detached. The tractor 105 can be decoupled manually or automatically from the semitrailer 110. If the third threshold value 240 is greater than zero, the tractor 105 can be lowered in order to be as completely as possible free from a support load of the semitrailer 110. The tractor 105 can then be moved forward away from the semitrailer 110.

If it was determined, in step 435, that a load of the semitrailer 110 is still resting on the tractor 105, which load exceeds the third threshold value 240, then it can be checked, in a step 445, whether a maximum adjustment range of the control system 400 has been reached. This may be the case in particular if one of the support legs 340 can no longer be extended further. If this is not the case, the method 400 can continue in step 415.

Otherwise, the extension of the support legs 340 can be ended in a step 450. In this case, the method 400 may end unsuccessfully in a step 455. The tractor 105 and the semitrailer 110 continue to be coupled to each other.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS (PART OF THE DESCRIPTION)

100 Vehicle system
105 Tractor
110 Semitrailer
115 Surface
202 Longitudinal axis
203 Left side
204 Right side
205 Absolute rolling angle
210 Relative rolling angle
215 Relative height
220 Scale
225 Value, in particular of a load
230 Amount
235 Range
240 Threshold value
245 Deviation
300 Control system
305 Control apparatus
310 First sensor
315 Second sensor
320 First actuator
325 Second actuator
330 Interface
335 Fifth-wheel plate
340 Support leg
342 Actuator of a support leg
344 Length
345 Load sensor
400 Second method
405 Requirement for automatic decoupling
410 Extend support legs
415 Determine load on support legs/wheels of the semitrailer
420 Load on left >load on right?
425 Extend support leg on right
430 Extend support leg on left
435 Load on tractor?
440 Release tractor and semitrailer
445 Maximum adjustment range reached?
450 Stop
455 Release or open coupling

1. A method for assisting a decoupling operation of a tractor from a semitrailer, wherein the semitrailer comprises a left support leg and a right support leg, which can be extended independently of each other, the method comprising;
determining a first load of the semitrailer, which acts on the left support leg;
determining a second load of the semitrailer, which acts on the right support leg;
individually extending a support leg of the left support leg and the right support leg, a load of which lies below an associated predetermined threshold value; and
releasing an opening of a coupling of the tractor to the semitrailer based on determining that a load of the semitrailer, which acts on the tractor, is less than a predetermined further threshold value.

2. The method as claimed in claim 1, wherein it is determined which of the left support legs and the right support leg supports a smaller load, and this support leg is extended while the other support leg is halted.

3. The method as claimed in claim 1, wherein the decoupling operation of the tractor is released only based on determining that an amount of a deviation between loads acting on the left support leg and the right support legs falls short of a predetermined threshold value.

4. The method as claimed in claim 1, wherein the decoupling operation of the tractor is released only based on determining that an amount of a deviation between effective lengths of the left support leg and the right support legs lies below a predetermined threshold value.

5. The method as claimed in claim 1, wherein the left support leg and the right support legs are extended in such a way that a deviation of an absolute rolling angle of the semitrailer from a vertical falls short of a predetermined threshold value.

6. The method as claimed in claim 1, wherein the left support leg and the right support legs are extended in such a way that an amount of a relative rolling angle between the semitrailer and the tractor falls short of a predetermined threshold value.

7. The method as claimed in claim 1, wherein a load acting on a support leg is determined based on a load acting on a wheel which is mounted on a same side as the support leg.

8. The method as claimed in claim 7, wherein the wheel is encompassed by the tractor.

9. The method as claimed in claim 7, wherein the wheel is encompassed by the semitrailer.

10. A control system for assisting a decoupling operation of a semitrailer having a left support leg and a right support leg from a tractor, wherein the control system comprises:
a first scanning device for determining loads of the semitrailer, which in each case act on the left support leg and the right support legs;
a left actuator for extending the left support leg;
a right actuator for extending the right support leg;
control apparatus for individually controlling the extension of a support leg, a load of which lies below a predetermined threshold value; and
a second scanning device for determining a load of the semitrailer, which acts on the tractor;
wherein the control apparatus is designed to release opening of a coupling of the tractor to the semitrailer based on determining that a load of the semitrailer acting on the tractor is less than a predetermined further threshold value.

11. A vehicle, comprising the control system as claimed in claim 10.

12. A vehicle system comprising a tractor and a semitrailer and the control system as claimed in claim 10.
